(19) United States
(12) Patent Application Publication
(10) Pub. No.: US 2009/0198580 A1
(43) Pub. Date: Aug. 6, 2009

(54) Distribution and Targeting of Advertising for Mobile Devices

(75) Inventors: Per Fredrik Broberg, Beverly Hills, CA (US); Hoa Le, Fresno, CA (US)

Correspondence Address: CONNOLLY BOVE LODGE & HUTZ LLP, P.O. BOX 2207, WILMINGTON, DE, 19899, US

(73) Assignee: Horizon Capital Securities Limited, Wilmington, DE (US)

(21) Appl. No.: 12/362,716

(22) Filed: Jan. 30, 2009

Related U.S. Application Data
(60) Provisional application No. 61/025,256, filed on Jan. 31, 2008.
(60) Provisional application No. 61/054,631, filed on May 20, 2008.

(51) Int. Cl. G06Q 30/00

(52) U.S. Cl. 705/14

(57) ABSTRACT

Advertisements are selected according to user profiles and selected advertisements may be downloaded offline to mobile devices and stored. Each advertisement may be associated with an advertisement header or auxiliary file specifying parameters of the advertisement. Content may be separately provided to the mobile device. Each content may be associated with a content header containing requirements or restrictions regarding the advertisements that may be shown in association with selected content.

### CROSS-REFERENCE TO RELATED APPLICATION(S)

This application claims priority pursuant to 35 U.S.C. §119(e) to U.S. Provisional Application No. 61/025,256 entitled “DISTRIBUTION AND TARGETING OF ADVERTISING FOR MOBILE DEVICES” filed Jan. 31, 2008, and to U.S. Provisional Application No. 61/054,631 entitled “DISTRIBUTION AND TARGETING OF ADVERTISING FOR MOBILE DEVICES” filed May 20, 2008, both of which are assigned to the assignee hereof and hereby expressly incorporated by reference herein.

### BACKGROUND OF THE INVENTION

1. Field of the Invention

The present invention is directed toward mobile devices that provide targeted advertising to users, and more particularly to mobile devices that preload advertisements based on user profile.

2. Description of the Related Art

Users of mobile devices (e.g., cellular telephones, palmtop computers, or the like) sometimes experience pauses or delays when attempting to download content, upload content, run an application, or otherwise access or utilize an informational or content service. During waiting times associated with such pauses, mobile devices typically display a blank screen, a status bar showing the status of the downloading process, information regarding the buffering of content (e.g., video clips, ring-tones, wallpapers, streamed TV, music, games, etc.). The user's attention may be easily diverted from the mobile display while the content is being downloaded or a service request is waiting to be fulfilled.

In addition, high impact advertising is typically limited to banner advertisements (“ads”), text ads, Multimedia Messaging Service (MMS) ads, or branding advertising, such as pre-roll or post-roll ads where the ad is essentially a part of the content. Accordingly, there is a need for a way to deliver high impact advertising that separates the delivery of the advertising from the delivery of the content to improve the timing of the display of ads to the user.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with methods for delivering targeted advertising to mobile device users. In one approach, the method involves storing ads onto a memory of a mobile device, wherein the ads may be selected from a library of ads based on a profile of a user. The method may further involve detecting a request for content from the user, and, in response to a waiting period associated with obtaining the requested content, displaying at least one of the stored ads to the user.

Each received advertisement may be associated with an ad header that specifies at least one ad parameter. The detected request may be for at least one content associated with a content header. The content header may specify rules regarding which ones of the received ads are to be shown in association with the at least one content.

In accordance with one or more embodiments and corresponding disclosure thereof, various aspects are described in connection with apparatuses for delivering targeted advertising to a user. In one embodiment, the apparatus for wireless communication includes a communication module adapted to receive ads selected from a library of ads based on profile of a user of the mobile device. The apparatus may also include a memory module adapted to store the received ads, a display module, and a processor module operatively coupled to the communication module, the memory module, and the display module. The memory module may include executable code for the processor module to: (a) detect a request for content from the user; and (b) in response to a waiting period associated with obtaining the requested content, instruct the display module to display at least one of the ads in the memory module to the user.

Each received ad may be included in or otherwise associated with an ad header or file specifying at least one ad parameter. The detected request may be for at least one content that includes or is otherwise associated with a content header or file. The content header may specify rules regarding which ones of the received ads are to be shown in association with the at least one content.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 provides a block diagram of an exemplary system for providing targeted and high impact advertising to a mobile device user.

FIG. 2 illustrates exemplary components of a process for providing targeted advertising via the use of proprietary headers.

FIG. 3 provides an exemplary side-by-side comparison of mobile devices downloading content for the mobile device users.

FIG. 4 illustrates exemplary delivery of two different ads to users viewing the same content on their respective mobile devices.

FIG. 5 provides a block diagram of an exemplary architecture for an ad delivery system.

FIG. 6 provides a block diagram of an exemplary mobile client and targeted advertising system.

FIG. 7 illustrates aspects of a targeted advertising system for mobile device users.

FIG. 8 illustrates aspects of the block diagram of FIG. 6.

FIG. 9 shows one embodiment for a method for providing targeted advertising to a user of a mobile device.

FIG. 10 shows one embodiment for a system for providing targeted advertising to a user of a mobile device.

### DETAILED DESCRIPTION

The present technology may be used to satisfy the need for a system and method of providing high impact advertising on a mobile device that is specifically targeted at the user of the mobile device and is presented to the user at an effective time.

Described herein are techniques for separating the delivery of the advertising from the delivery of the content to mobile devices, and for improving the timing of the display of advertisements to mobile device users. Perceived delays associated with downloading ads are removed because the ads are pre-loaded, i.e., loaded onto the mobile device or handset prior to the user's content or service request. It is noted that the ads may be downloaded to the mobile device in traditional time frames, established according to known mobile advertising methods.

An additional benefit of the ads being pre-loaded is that the bandwidth use to deliver the ad occurs at a different time than when a user request for content occurs. This makes it possible to deliver ads asynchronously in response to user requests, thereby spreading bandwith utilization over a broader time period. Another benefit to this technology is that ads to be preloaded onto the mobile devices may be compressed into smaller data packets than in the case for a streamed ad or the like. A further benefit of this technology is that it removes the need for third party content, application, and other services, and advertisers, to have billing and network deals with carriers, advertising aggregators, and their partners since content creators, application developers, and service providers may now be subsidized by advertising delivered to mobile device users who have any network connection, independent of the carrier subscription.

In accordance with one or more aspects of the embodiments described herein, the present technology involves providing mobile devices preloaded with ads based at least in part on a user profile, providing content, and selecting one or more preloaded ads to be shown to the user as the content is prepared for the user (e.g., as the content is being downloaded or buffered). The present technology provides high impact advertising that specifically targets the mobile device user, such as for display to the user while content is being uploaded, downloaded or buffered for the user, by trigger from another application, WAP (Wireless Application Protocol) or WEB (World Wide Web) portal, or at other times and by other triggers. In particular, a system and method for delivering such targeted advertising (e.g., video advertising) while the mobile device is downloading or buffering content for the user is disclosed herein.

Content may include such things as ring-tones, wallpaper, streamed TV, video clips, music, games, other digital data, etc. Additionally, ad playback may be triggered though an application programming interface access by other applications and games installed on the device, web pages a user is accessing, a WAP portal that the user is visiting, or service being accessed.

Described herein are methods for delivering advertising independently from content and then combining advertising and content, service request, and other user initiated actions on the handset, subject to rules that may be provided in content headers at the point of transaction, preconfigured on the mobile device itself, or data referenced thereby. It is noted that this same platform may be used to serve traditional advertising like banners adds, images, animated images, text ads, and original content as well.

In related aspects, tagging refers to adding, including, or otherwise associating a header or header file with a given content and/or a given ad. Such headers or tags may be read by a handset application, and preferably allows content downloaded onto a handset or mobile device to be managed according to the techniques described in further detail below. The handset application may comprise a proprietary piece of software installed on the handset and may perform multiple tasks, including but not limited to reading the headers/tags associated with the content and/or ads, and managing the contents and/or ads according to information in one or more of the headers. Proprietary headers may be tagged to or otherwise associated with the content, the ad, streams, etc. Such headers may include information on the file (e.g., metadata), play-out rules, exclusions to what other ad/content it can be played with, and digital rights management (DRM) data.

An application on the mobile device may download the ad files in the background with no user interaction. With respect to the downloaded or pre-loaded ads, the application may read proprietary headers of the ad files, headers in the content itself, URI information in the session exchange, and may process the information accordingly to determine which specific advertising to play. By downloading the ads in advance and saving them on the mobile device, it is possible to provide ads with less disruption to the user's experience. In addition, the ad may be selected independently of the content and targeted specifically to match a user profile. Because the ad is relevant to the user, it should be more interesting to the user and more valuable to the advertiser. Because the ad is retrieved from the mobile device's memory, its provision does not delay the download of the user's chosen content. In addition, the ad may be downloaded to the mobile device at a time to suit the network, thereby better managing the demand for bandwidth. Also, it is noted that downloaded ads may be more easily provided in higher quality than streamed ads because bottlenecks to high-bandwidth downloaded are more easily managed.

An application on the mobile device enables targeted advertising (e.g., video, still image and audio) to be downloaded to the mobile device, and then combined on the device with content chosen by the use, including but not limited to, wall paper, screen saver, music tracks (e.g., mp3 or WMV), video, games, and other digital content. The ads may be downloaded in advance to individually chosen handsets, and targeted handsets may be selected on the basis of the demographic profile of the handset user. The ads may be stored in a part of the handset that the user cannot access, and remain there until they are required. The application may be configured such that no user action is required when the ads are downloaded to the mobile device and the ads may be downloaded and stored without the user being aware of this.

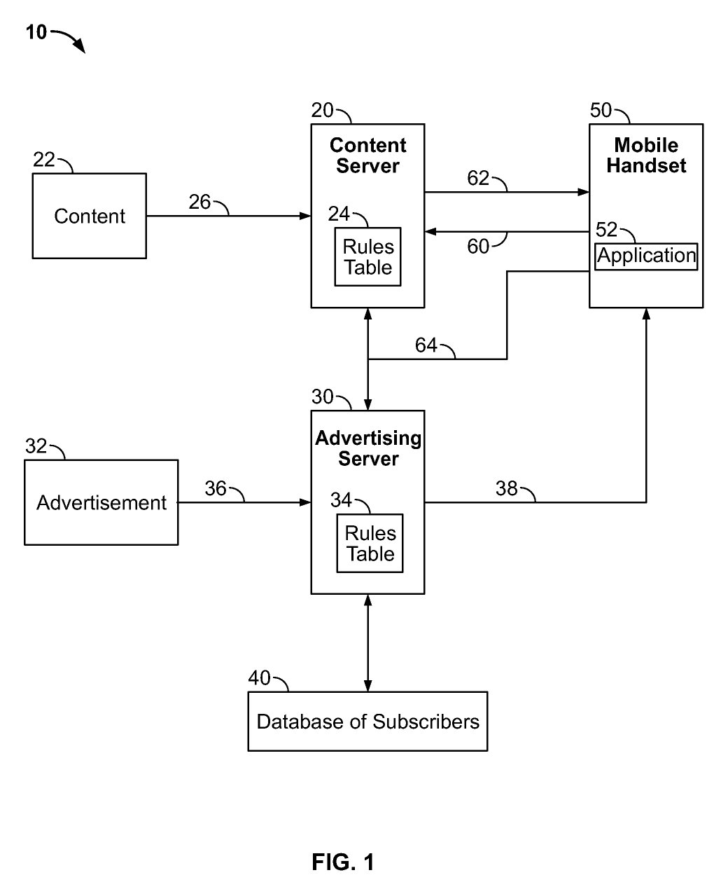

With reference to FIG. 1, there is provided one embodiment of a system 10 for the distribution and targeting of advertising for users of mobile devices or handsets 50. The system 10 may generally include a content server 20, an advertising server 30, and a user database 40. A content 22 (e.g., video content), or piece/portion thereof, may be uploaded to the content server 20, and a rules table 24 may be generated (step 26). The content server 20 may hold the content 22 from which the mobile device user may select content. Similarly, an ad 32 may be uploaded to the advertising server 30 and a rules table 34, which identifies who the ad 32 will go to, may be created (step 36). The advertising server 30 may hold the ads 32 that are to be sent to the mobile device user.

The advertising server 30 may be in communication with a database 40, which may include the registration details of mobile device users or service plan subscribers, their current and historic usage of content, their viewing history of ads and additional analytics and data. Such information stored in the database 40 may be used to target ads to each user's mobile device or handset 50.

In related aspects, the advertising server 30 may comprise or otherwise be in operative communication with an advertiser's web portal adapted to provide the tools an advertiser may need to plan, book, and provision their advertising campaign. Such tools or available resources may include, but are not limited to: targeted ads within the carrier's user base based at least in part on age, location, gender; a system/module for uploading, formatting, and compressing ads; a budgeting software application; a reporting system/module that keeps the advertiser current on which ads were delivered and/or played-out on the users' mobile devices; etc.

In further related aspects, the content server 20 may comprise or otherwise be in operative communication with a content owner's web portal adapted to provide the tools a content owner may need to upload and manage content. Such tools or available resources may include, but are not limited to: a system/module for tagging, adding, or associating rules with the content (e.g., which types of ads may be played with the content); a short-code activation system/module adapted to assigning short-code activation numbers or the like that a user may send in order to obtain the content; a reporting system/module that keeps content owner current on how many people have downloaded the content, how much revenue that piece of content has generated, or the like; etc.

Handset application 52 may be installed or stored in a memory of the mobile device 50 for handling advertising and/or performing other functions. It is noted that the rules tables 24, 34 detail the parameters for each content/advertising and may be read by the mobile device application 52, thereby controlling which content/ads may be stored and/or displayed on each user's respective mobile device 50. The rules tables 24, 34 may be accessibly linked to and/or included as part of corresponding ads or content, other triggering events, and/or specifically called by an external application or service associated with a given mobile device 50. That is, each discrete ad or content file may include its own rules table or called into service by external triggers.

The application 52 may be resident on the handset or mobile device 50 and may control how the mobile device 50 handles the specific pieces of advertising and/or user-selected content that it receives. The application 52 may be sent over the air (OTA) via any network (i.e., network agnostic, CDMA, GPRS, etc.), loaded via adjacent connection to a network enabled device (e.g., PC, network appliance, etc.) and may be sent to a large number of existing mobile devices of which device 50 is representative of one exemplar. In the alterative, or in addition, the application may be pre-installed, such as by the carrier or mobile device manufacturer before the mobile device 50 is supplied to the user. Additionally, the application 52 may be bundled with other applications so that it is installed as part of the their installation mechanism.

In related aspects, the handset application 52 may be adapted to connect automatically to a server to collect or downloaded according to a specified schedule and/or when defined triggering events occur. The application 52 may be adapted to automatically download ads and/or associated headers, wherein each header which may contain details regarding when associated ad(s) can be played and/or the types of content the ad(s) can be played in association with (e.g., before, during, in conjunction with, after the content). The downloaded ads may be stored in secure section or memory of the device 50. When the user selects content, the application 52 may play the ad while the use's chosen content is downloading or being buffered.

One or more ads 32 may be downloaded to those mobile devices 50 that match a given advertiser's targeting specification, as defined in the rules table 34 of the advertising server 30 (step 38). The ads 32 may be downloaded to the mobile device 50 in advance and/or in the background without the user having to do anything. When the user requests content 22 (step 60), the content 22 may start to download or buffer on the mobile device 50 (step 62), at which time selected ones of the ads 32 stored on the mobile device 50 may start to play for the user. At pre-determined times (e.g., tied to a specific user activity or triggered by other defined events) the mobile device 50 may establish communication with the servers 20, 30 to report on its content and advertising playout (step 64).

Further with respect to the application 52 on the mobile device 50, the application 50 may recognize a received ad 32, and may automatically store the received ad 32 in a secure part of the phone's memory. The application 52 may read a header file included in, associated with, or otherwise relating to the ad 32. The header file may contain the rules about the ad 32, such as, for example, the rules regarding when the stored ad 32 may be played for the mobile device user.

In related aspects, the rules for any specific ad may be encoded into a header file which may be sent to the chosen handset—either with the advertising copy, or independently of the handset copy. The handset application 52 may read the header file, and manage the ad appropriately. The header file may be sent/received independently of the ad 32, enabling the ad 32 to be downloaded in advance while the rules relating to that ad 32 are sent or amended at a later stage. The application 52 may be adapted to detect when the user chooses a content 22 on the content server 20 via a content header file that details which types of ads can be played with or in association with the content 22 (e.g., which ads may be displayed before, during, after user-selected content is displayed to the mobile device user). For example, the content header file may contain information about which types of ads 32 may be permitted to appear next to or in conjunction with the content 22, and/or are restricted from appearing with the content. For example, if the content is a cartoon for young children, then a beer ad may be specifically prohibited from appearing before that content. It is noted that the mobile device 50 may receive the header file before or after the mobile device receives the content, such as, for example, user-selected content.

The application 52 may interact with other applications or device modules that may be installed on or otherwise in communication with the mobile device 50. For example, the application 52 may be capable of, or otherwise adapted for, interacting with a WEB portal or a WAP portal. Other applications (e.g., WEB portal and/or WAP portal) may also invoke the application 52 to play advertising, inquire about the existing ad inventory on the device, schedule the display of ads, update advertising schedules, update advertising or seek related details, and perform one or more of the functions that the application 52 may otherwise perform.

As content 22 downloads (or buffers, in the case of streamed content), the application 52 may select the appropriate ad 32 from its memory (having been downloaded in advance) and play the ad 32. As the ad 32 plays, the system may show a “download in progress” bar or the like, so that the user knows the ad 32 is not delaying their content. During or after the ad 32 has played, the content 22 finishes downloading and the user may optionally be asked if he/she would like to view that content 22.

In related aspects, a static menu may be displayed on the mobile device 50, during and after the content 22 downloads. This menu on the mobile handset 50, may be a platform for further advertising, a link to other resources, etc. At regular or defined intervals, the handset application may check to see if there are any more ads that it should download, and report back regarding the ads and/or content that it has played for the mobile device user since it last reported to or checked in with the servers 20, 30, and/or 40. Advertisers and/or content owners may be provided with audit reports or the like via the handset application 52 and/or compatible applications, applets, etc.

Further with respect to the advertising rules table 34, the rules table 34 may comprise a database that includes rules relating to one or more of the ads received, stored, or transmitted by the ad server 30. The advertising rules may include, but are not limited to, the users age (or age range), gender, location, and specified interests (e.g., hobbies, favorite televisions shows, etc.). For example, from time to time, the system may augment the registration data by asking “what type of music/movies/etc. do you like?” via the static option window after or during content download.

Further with respect to the content rules table 24, the rules table 24 may include the rules relating to each specific piece of content 22. The content rules may include, but are not limited to, the ages of the users who may access the content 22 (e.g., some content 22 may be inappropriate for underage viewers), and DRM information relating to content 22.

Further with respect to the subscriber database 40, the database 40 may include information regarding those subscribers with the handset application 52 installed on their mobile devices 50, which in turn may facilitate the delivery of highly targeted advertising to the subscribers. The database 40 may collect the registration details of the users when the users first access content 22. The database 40 may comprise data that wireless carriers have regarding its customers. The database 40 may also include data about the content that a given user has downloaded and paid for without advertising. Likewise, the database 40 may contain details about the physical or geographic location of the handset that may be inputted by the user or other applications, and/or inferred from device resident technologies, such as, for example, GPS, AGPS, cell tower ID, etc. Other usage activity on the mobile handset 50, or other usage type information that has been measured, inferred, or imported from external sources may also be uploaded to the database 40. The users may be able to access and update their preferences or registration details over the web or via their mobile devices.

In related aspects, after play-out (i.e., after the application 52 plays the ad on the device 50), the application 52 may leave the played ad in secure memory when the associated content is scheduled to play multiple times on the handset, or may display the on-screen message “user can save copy to their removable memory, or content will be permanently deleted” or other similar message when the scheduled number of ad play-outs has been achieved. The application 52 may be adapted to provided the user with the option of forwarding the ad to his/her friends.

In further related aspects, the ad 32 may be linked to an advertiser's WAP site. For example, the ad 32 may be interactive and can be clicked on during and/or from a splash screen transmitted at the same time as the ad 32. The splash screen may be shown at the end of the content, and may be called up from a memory module of the device 50 by the user. A handset soft key may be programmed with a “click key to activate WAP link” function, and may be assigned to connect to the URL embedded associated with the ad 32 and/or splash screen. In another example, coupons may be sent to the user according to their demographics. The user may also request a coupon for a specified product type or from a given advertiser. The user may send a message to a short-code with the product category or advertiser name in the text, and may receive a coupon in return.

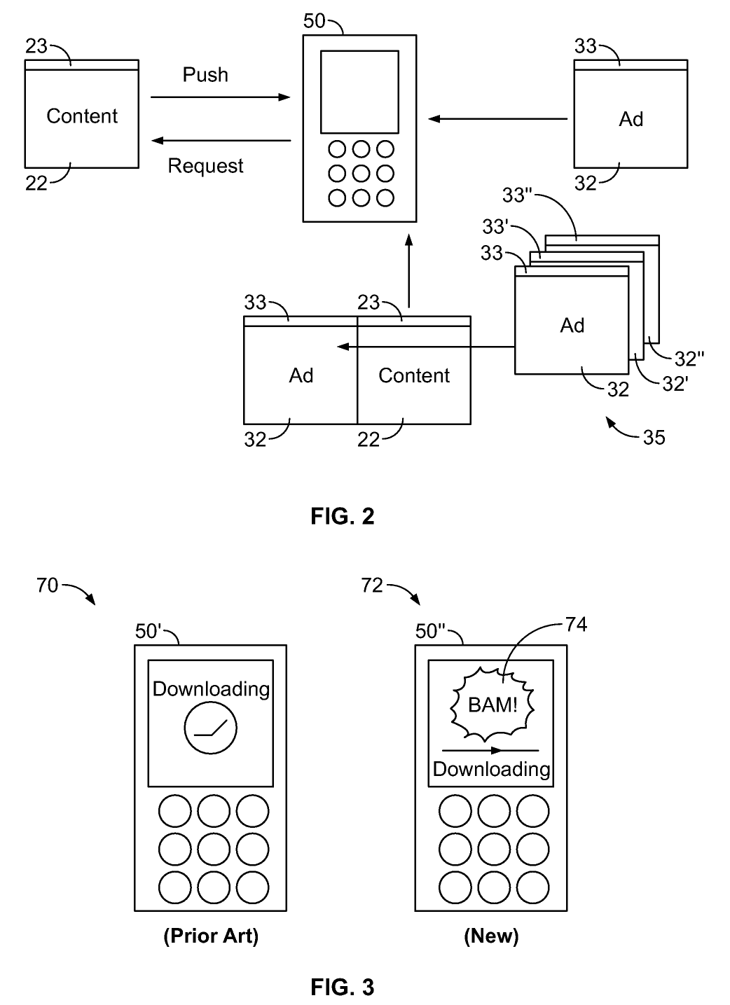

With reference to FIG. 2, there is provided a mobile device 50 having a handset application 52 (not shown) or the like installed on it. Each content item 22 may be tagged with a content header 23, and each ad 32 may be tagged with an ad header 33. A deck or stack 35 of ads 32 may be preloaded on the mobile device 50 based on the user profile, which may be created from information in a subscriber database 40 or the like. When the user selects the content 22, the application 52 may read the content header 23 and select an appropriate ad 32 from the stack 35 of ads that were preloaded onto the mobile device 50. The selected ad 32 may be played while the content 22 is being downloaded or buffered. This way, the content 22 may be played for the user in seamless fashion. The play-out data (e.g., data regarding which content/ads were played, when and how many times the content/ads were played, etc.) may then be sent to one or more servers, such as, for example, servers 20, 30, and/or 40 shown in FIG. 1.

In related aspects, the handset application 52 is generally installed on the mobile device 50 before the ad-tagged content described herein is delivered to the device 50. In one embodiment, specific carriers may pre-install the application 52 on new handsets or mobile devices before they are provided to their customers, and/or may install the application 52 OTA to some or all of their subscriber base. The application 52 may be adapted to self-install, without the mobile device user having to perform affirmative installation steps. In another embodiment, the application 52 may be pre-installed on the mobile devices supplied by a device manufacturers or original equipment manufacturer (OEM) to a carrier.

In yet further related aspects, content owners may require a mobile device user to OTA install the application 52 when the user requests content. For example, the content owner may add a short-code or the like to their ads promoting content. Receipt of the code may initiate a check of the user's device to see if the application 52 is already installed. If not, the application 52 downloads to the user's device, and an optional opt-in request may be presented to the user before the content is delivered. The application 52 may self-install such that no or minimal user interaction is required. Delivery of the application 52 may include the first ad and a welcome video or the like. It is noted that the short-code may optionally be provided to the content owner by a third-party, particularly in situations where the third-party provides the content owner with technology enabling the content owner to sell more content.

In still further related aspects, the association of a given ad with a given content (e.g., the insertion of the given ad into the given content) may occur on the device 50 itself, wherein the ads are delivered independently of the content. Typically, the ads are downloaded and stored on the device 50 in advance of the request for content. There are several ways in which the ads may be tagged to or otherwise associated with the content, and four examples are described in further detail below.

In a first example, relating to on-demand content (e.g., an impulse purchase of content by a mobile device user), the consumer decides that they want a given content “there and then.” The consumer requests the content and “pull” it onto his/her handset and will typically have to wait for the requested content to download or buffer. The previously installed ad may play while the download/buffering is occurring, optionally with an on-screen message reassuring the consumer that the ad is not delaying the download/buffering.

In a second example, relating to subscription content (e.g., content that is pre-ordered), the consumer subscribes to content that is regularly provided to him/her, such as, for example, a subscription for a daily update on a favorite television show. The content does not need to be sent “there and then” for instant playing, so the content may be downloaded and stored on the device 50 over night, and may be scheduled to play on the device 50 at a specified time. In essence, the content may be “pushed” to the handset in the background without the user even being aware. At the specified time, the user may see an on-screen message telling him/her that the content is ready is available (e.g., similar to a “text received” message in a short message service (SMS) context). The user may have the option to view the content “there and then,” or may access it a more convenient time. When the user decides to view the content, the stored ad may be triggered for display, followed by the content. In one approach, the handset application is adapted such that the stored ad has to be viewed before the content can be accessed (i.e. the user cannot bypass, fast forward through, or delete the stored ad).

In a third example, relating to in-application events/triggers, the consumer may be actively engaged with a content that requires the device 50 to upload and download data to a server. While the upload and/or download is talking place, an ad stored (e.g., a short video ad) on the device 50 may be played, similar to the first example described above involving on-demand content. If there are multiple such events/triggers within the content, different ads may be played for the consumer.

In a fourth example, relating to streamed content, an ad may be displayed when the streamed content is buffering and/or downloading on the device 50. This is believed to be an improvement over known approaches wherein, when a consumer clicks to view streamed content, he/she experiences a delay or dead period while the content buffers. Such a delay would compounded if an ad has to be streamed and played before the content. However, the technique described herein involves downloading the ad in advance, such that the ad plays on the handset the moment the consumer clicks to view the content. Mean while, the streamed content may buffer in the background and may be ready to play when the ad is done playing.

With reference to FIG. 3, there is illustrated the monetization of dead time, for example, when content is being downloaded or buffered for the user, when a user accesses a streamed TV channel, etc. In the illustrated scenario 70, which represents the prior art, mobile device 50′ displays a counter ticking away or a status bar while the rest of the screen remains blank. In scenario 72, which displays one or more aspects of the targeted advertising techniques describe herein, there is illustrated an improved mobile device 50″ that displays a preloaded high impact ad 74, such as a video ad or the like, while the requested content is being downloaded onto the mobile device.

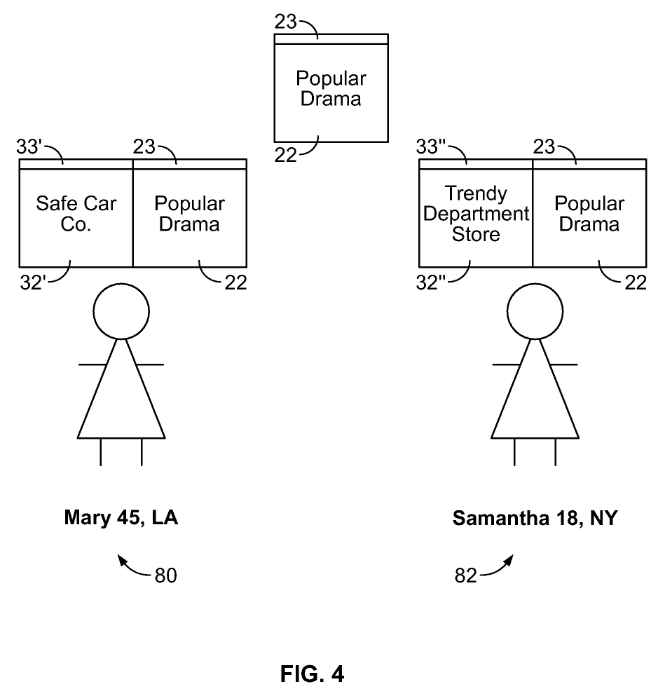

With reference to FIG. 4, there is provided an exemplary manner in which ads may be targeted to two different users who view the same content 22, in this example the television show Popular Drama. As explained previously, content header 23 may include rules regarding the types of ads that can and cannot be shown with the content 22. In the present example, the rules in content header 23 allow both ad 32′ (for Safe Car Co.) and ad 32″ (for Trendy Department Store) to be shown to content viewers. On one hand, user 80 (Mary, age 45, residing in Los Angeles, Calif.) owns a mobile device preloaded with an ad stack that includes ad 32′. As a result, a high impact ad for Safe Car Co. may be shown to Mary while she waits for Popular Drama to download or buffer onto her mobile device. On the other hand, user 82 (Samantha, age 18, residing in New York, N.Y.) has a mobile device preloaded with an ad stack that includes ad 32″, which is shown to her while she waits for Popular Drama to download or buffer onto her respective mobile device

Accordingly, benefits of the present technology include: optimal usage of dead time to display high impact advertising on a mobile device; filtering of ads that are inappropriate for display with a given content; and specific targeting of ads to users based on the user's profile and location rather than the content. Again, it is noted that the ads are based on the user's profile rather than the content. This way, both viewers see the same content 22 but different ads 32′ and 32″. Such targeted advertising is particularly beneficial where the content 22 (e.g., Popular Drama) is distributed to a broad demographic of viewers.

In related aspects, the user profile information may be gathered when the user first accesses content or when the user is prompted to register and opt-in. When the system is licensed to a carrier, that carrier may be given the option not to use this registration or opt-in process. It is noted that carriers may have information regarding their subscribers, which may be incorporated into or used by the subscriber database 40.

In further related aspects, the content may be selected by the user. The content may be downloaded over the air (OTA) from a web site, streamed from a web site to the handset, etc. A streamed piece of content may first buffer on the handset before starting to play or a pause in a game, application or service the user is accessing on their mobile device. When the content is selected by the user, and as that content is downloading or buffering, the ad may play on the handset. The pause or waiting period, or other trigger or trigger event in a game or application installed on or associated with the mobile device may result in the ad being play on the handset. The playing of the ad preferably does not reduce the speed of the download or buffering, interfere with the nature of the game, application, or service outside of a programmed paused, and the user may access the content, game, application, or service of their choice as quickly as they otherwise would. This creates the opportunity for the owner of the content, games, application, and services to generate or share in a revenue stream from the advertiser, and to pass some of that benefit to the user for seeing the ad (i.e., in the form of subsidizing the cost of the content or to the point of making the content free of charge). Accordingly, the targeted advertising techniques described herein make it possible to implement an “ads finding the cost of content” business model in the content of mobile advertising/content.

An aspect of the embodiments described herein involves creating a user profile which can be created by the user or based on other data. Another aspect of the embodiments described herein includes the delivery of ads to the handset in the background, without the need for user interaction, based on the profile of the user and not based on the content they are accessing. Still another aspect of the embodiments described herein includes the use of proprietary headers tagged to the content and ads, which may include the play-out rules that tell the application the rules of the advertising campaign and any DRM. When a user accesses a content, the application reads the proprietary header associated or attached to the content. This header may contain the play-out rules such as type of ad that should be associated or cannot be associated with the content. It may also contain any rules for DRM. Once the application has read the header associated with the content, it may select and play-out the appropriate ad which have been downloaded in advance on the handset, and also triggers the download or streaming of the content.

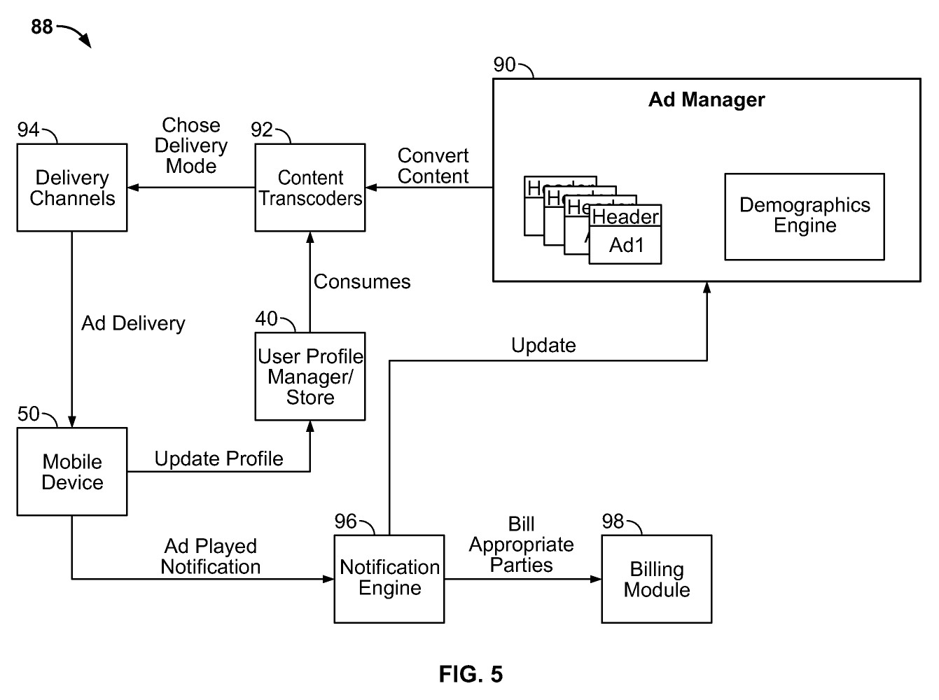

With reference to FIG. 5, there is provided a general overview of an exemplary architecture for an ad delivery system. In one embodiment, the ad delivery system 88 may comprise an ad manager 90, content transcoders 92, delivery channels 94, a notification engine 96, and a billing module 98, each being in operative communication with each other.

With respect to approaches for ad delivery to a mobile device 50, the device 50 may make a pull request, or the device 50 may receive a notification regarding available ads that may be downloaded. For a device 50 to get notification it may use the operator's push mechanism and/or, for pull model, there may be a native application or virtual machine VM) based application that polls the ad server(s) for new or updated ads, if any. The ad manager 90 may comprise or otherwise be in operative communication with one or more ad servers.

The ad manager 90 may be in operative communication with one or more content transcoders 92, which in turn may transform the content of an ad to a format and size that best suits the mobile device 50. The system 88 may include one or more delivery channels 94 to send the ads to the device 50. Each of the ads received by the device 50 may also have a set of rules for used by the device 50 to display the appropriate ad. The ad manager 90 may store the ads and it may also have the capability to poll external world entities for new ads. Polling the external world may allow the ad providers to maintain and manage ads. The ads may be coupled with headers to enable the technology to pinpoint the targeted users.

The user profile database 40 or the like may store various information of users, such as, for example, preference, gender, geographic location, date of birth, and mobile device specific details like current content usage, historic content usage, game play, application use, service requests, etc. Ad manager 90 may update the user profile module/database 40 to identify the targeted audience. When an ad is successfully played on the mobile device 50, the device 50 may send (instantly or at a later time) a notification to the notification engine 96, which in turn updates the ad manager 90, thereby allowing the ad manager 90 to gain information regarding successful delivered ads. The notification engine 96 may also notify a billing module 98 so that appropriate parties can be billed. Billing module 98 may be adapted to generate billing information that complies with industry standards, which allows the billing module 98 to become easily integrated with any internal billing systems, as well as external entities like operators, ad providers, content providers, and device manufacturers.

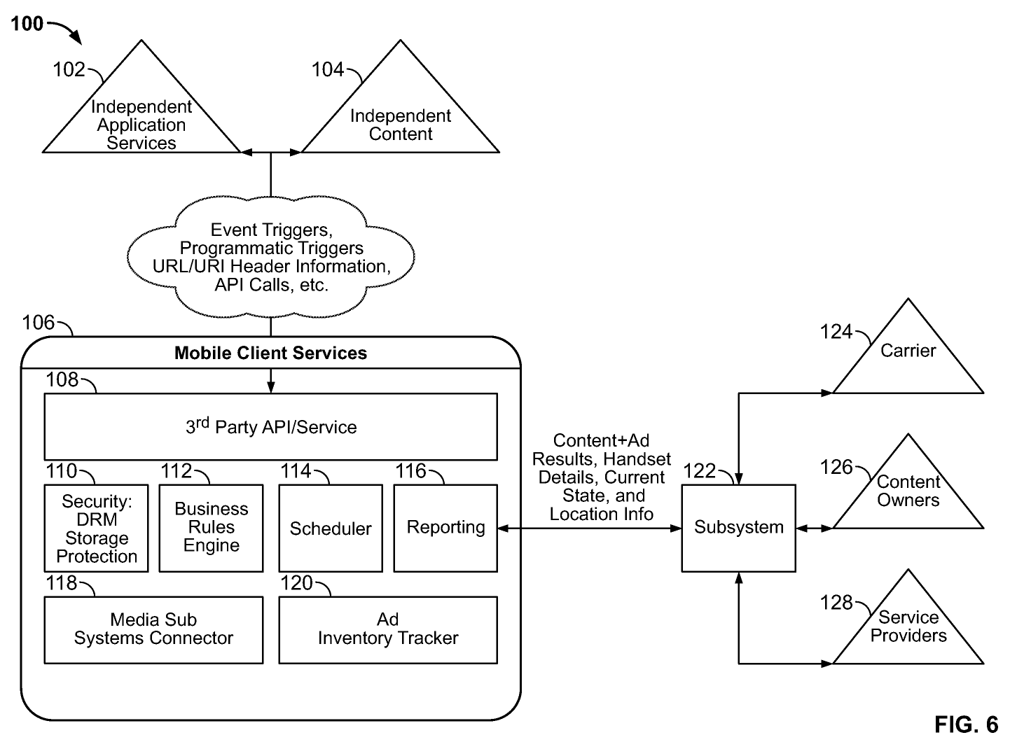

With reference to FIG. 6, there is provided an exemplary system 100 through which a mobile client (e.g., a handset application running on a mobile device) may interact with wireless carriers 124, content owners 126, and/or service providers 128. The system 100 may comprise a client 106 in operative communication with subsystem 122, described in further detail below, which in turn is in operative communication with a wireless carrier 124, a content owner 126, and/or a service provider 128.

The client 106 may be in operative communication with an independent application service 102 and/or independent content provider 104, such as, for example, those services and providers associated with the entertainment industry or social networking sites. It is noted that content providers may include organizations or individuals who own content, such as, for example, movie studios, video/computer game studios, music labels, media owners, etc. Content providers may also include organizations or individuals who are content aggregators, or effectively operate as content supermarkets.

The client 106 may be in operative communication with the independent application service 102, the independent content provider 104, or the like, via the Internet or any other known communication media and protocol. The application service 102 and/or independent provider 104 may send event trigger, programmatic trigger, uniform resource locator (URL), uniform resource identifier (URI) header information, application programming interface (API) call, or the like, or combinations thereof to the client 106.

In related aspects, the client 106 may be a plug-in on a mobile handset, and may include a first layer comprising a third party API or service module 108. The third party API/service module 108 may include libraries, code, or the like that allow third parties to communicate directly with the client 106 on the handset.

A second layer of the client 106 may comprise a security/digital rights management (DRM) storage protection module 110, a business rules engine 112, a scheduling module 114, and/or a reporting module 116. The security/DRM storage protection module 110 may be adapted to keep track of content and ads on the handset, and may be further adapted to protect digital rights via propriety coding, protection from deletion, etc. The business rules engine 112 may work with the scheduling module 114 and the reporting module 116 to manage the scheduling and reporting of ads. The reporting module 116 may keep track of the handset user's usage and ad playback, as well as ancillary user details, such as, for example, when and where he/she is using the client 106 (e.g., location, time, date, GPS data).

A third layer of the client 106 may comprise a media subsystems connector 118 and/or an ad inventory tracker 120, both of which are adapted for interfacing with the handset operating system (OS). The media subsystems connector 118 may be adapted to connect the client 106 to other application and features that are resident on the handset. The ad inventory tracker 120 may interact with the OS of the handset to keep track of media assets, such as, for example, memory, size, location, in order to make sure the ads are properly stored on the handset device.

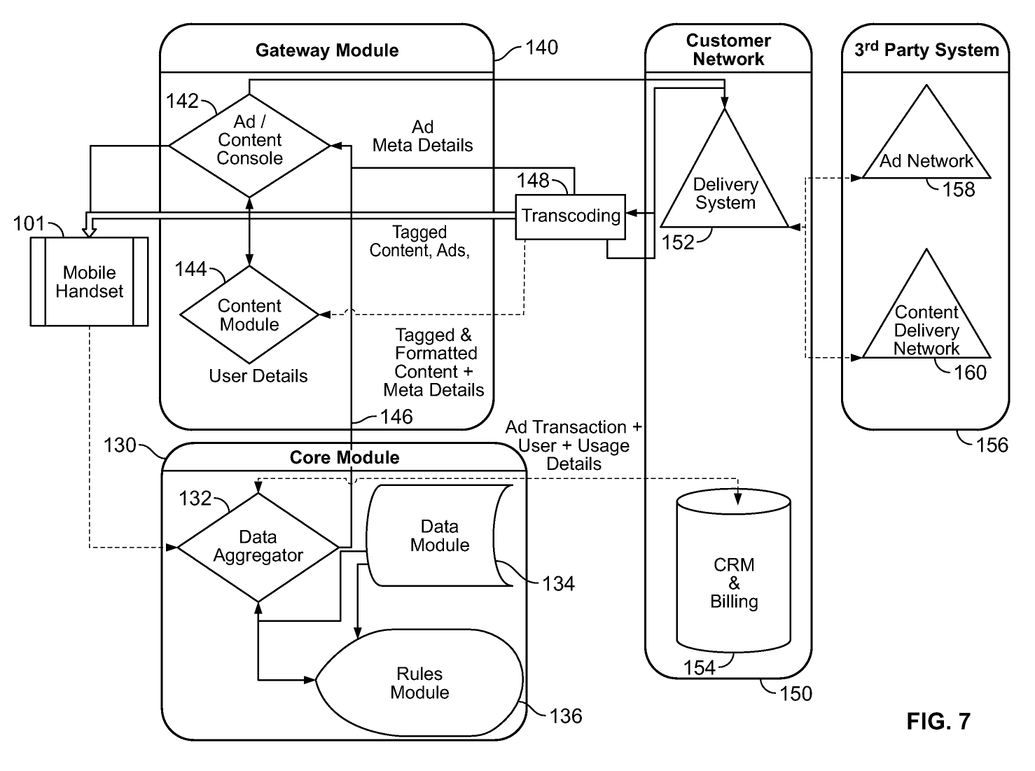

Content and ad results, handset details, current state and information may be communicated between the second layer of the client 106 and subsystem 122 through internal programming functions, APIs, protocols, methods, etc. and/or methods of communication provided by the resident OS on the mobile device. Subsystem 122 may comprise a core module 130 and gateway module 140, illustrated in FIG. 7.

With reference to FIG. 7, the core module 130 may comprise a large database that keeps track of and/or logs user information and transactions, such as, for example, which ads are played, where the ads are played, what content was request when the ad was played. Such logged data may be shared with advertisers and other interested parties (e.g., carriers, mobile network operators, content developers, content owners).

In one embodiment, the core module 130 may comprise a data aggregator 132 in operative communication with an analytics/third party data module 134 and a rules module 136, which may include ad rules, content rules, ad/content filters, revenue/billing rules, etc.

The data aggregator 132 of the core module 130 may receive information regarding the time, date, and place that the ads are played from the client 106 on a mobile handset 101. In the alternative, or in addition, the data aggregator 132 may receive information regarding the content downloaded/uploaded, games played/paused, etc. from the client 106. The data aggregator 132 may receive analytics data from the analytics/third party data module 134. The data aggregator 132 may also receive and/or send information from the rules module 136, such as the results and data for a given advertising campaign. The analytics/third party data module 134 may send user/advertising campaign details to the rules module 136. The data aggregator 132 may share information regarding ad transactions, the handset user, and usage details with a customer relations management (CRM)/billing module 154 of a customer network 150. Further, the data aggregator 132 may share information regarding user details 146 that may be from the analytics database 134, from the CRM/billing module 154, and from an ad/content console 142.

The gateway module 140 may comprise the ad/content console 142 in operative communication with a content module 144. The ad/content console 142 may send an ad schedule and content/ad rules files to the mobile handset 101, as well as to an ad/content delivery system 152 of the customer network 150. It is noted that the core module 130 and the gateway module 140 may be located on the same server. In the alternative, the core and gateway modules 130, 140 may be located on different servers.

A transcoder module 148 may be in operative communication with the ad/content console 142 and the content module 144. The transcoder module 148 may send ad meta details to the ad/content console 142, and may send targeted and formatted content and meta details to the content module 144. The transcoder module 148 is generally adapted to receive unmodified content and ads, transcode the received content and ads, and send tagged content and ads to the mobile handset 101. In the illustrated embodiment, the transcoder module 148 is a standalone module or system. In the alternative, or in addition, the transcoder module 148 may be part of the gateway module 140, the core module 130, the customer network 150, or a third party system 156.

The customer network 150 may belong to or function on behalf of the wireless carrier 124, the content owner/developer 126, the service provider 128, etc. The customer network 150 may have an ad/content delivery system 152 and a CRM/billing system 154. The ad/content delivery system 152 may be adapted to receive the ad schedule and content/ad rule files from the ad/content console 142. The ad/content delivery system 152 may access the ad network 158 and content delivery network 160 of the third party system 156. For example, the ad/content delivery system 152 may retrieve and relay video, pictures, ring tones, etc. from the content delivery network 160, along with ads from the ad network 158.

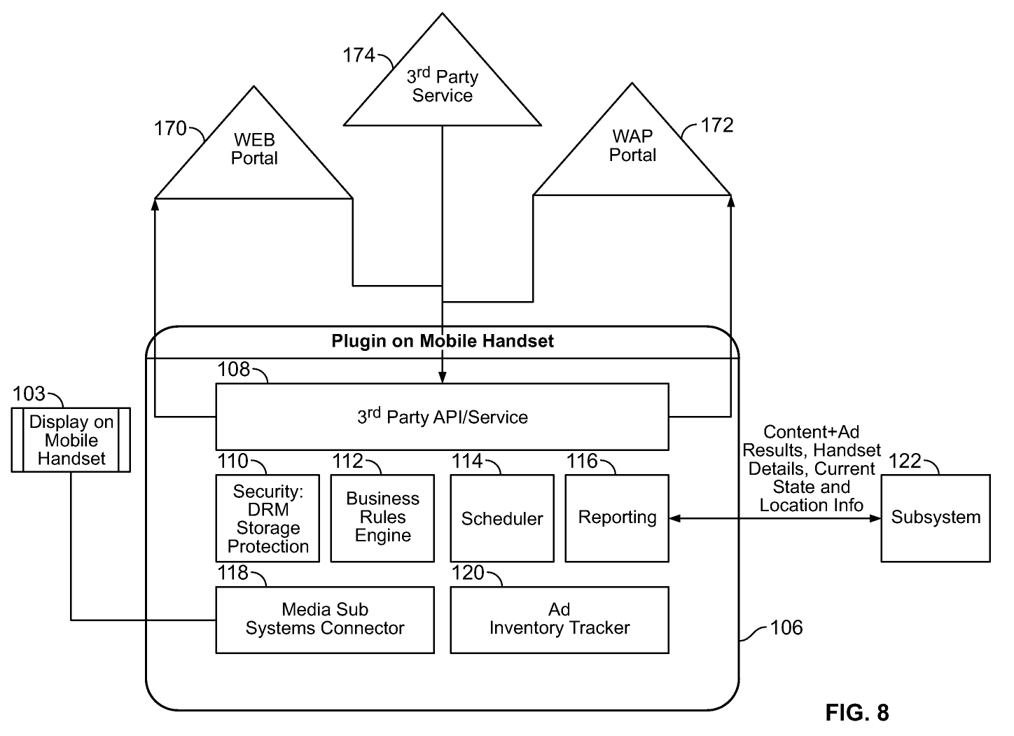

With reference to FIG. 8, the client 106 may be in operative communication with a WEB portal 170, a WAP portal 172, and/or a third party service site 174 providing services, applications, games, etc. The WEB and WAP portals 170, 172 may receive information regarding ad inventory, ad playback results, client state (e.g., version of software installed, whether correct permissions have been applied, integrity of binaries and content, etc.), and handset details (e.g., location) from the third party API/service module 108 of the client 106 or the like via customized API, other programming and database methods, standard web services methods embedded in the URL, URI header, datagram packet itself, etc. The WEB and WAP portals 170, 172 may send URL header triggers, direct java calls, direct API calls, etc. to module 108. The third party service site 174 generally sends Java library/API calls, native API calls, etc. to module 108.

The media subsystems connector 118 may be in operative communication with a display 103 of the mobile handset 101 to provide ads, static/interactive menus, coupons, user-targeted content/ads on the display 103.

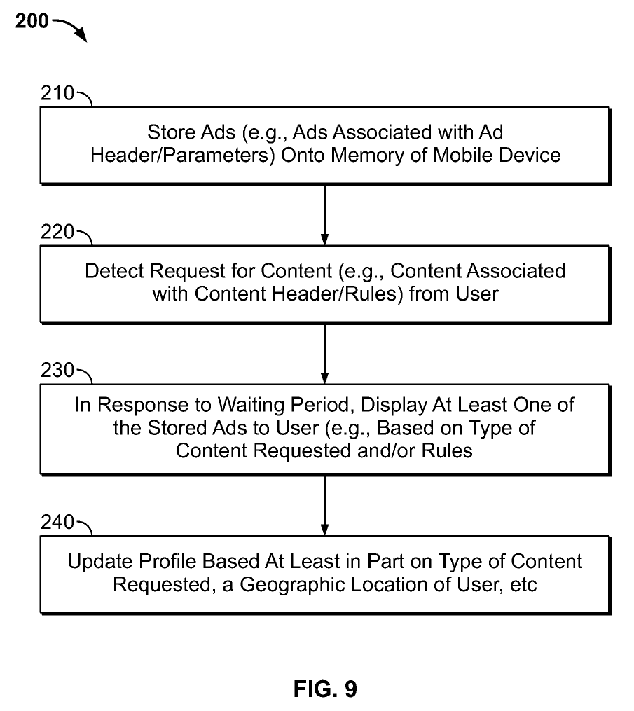

In accordance with one or more aspects of the embodiments described herein, there are provided methods for delivering targeted advertising to mobile device users. With reference to the flow chart shown in FIG. 9, there is provided an exemplary method 200 that involves storing ads onto a memory of the mobile device (step 210). The ads may be selected from a library of ads based on a profile of the user. At step 220, the method 200 may involve detecting a request for content from the user. In response to a waiting period associated with obtaining the requested content, at least one of the stored ads may be displayed to the user (step 230). The method 200 may involve (at step 240) updating the profile based at least in part on a type of content requested by the user, a geographic location of the user (e.g., the user's hometown or the current location of the user's mobile device), etc.

In related aspects, step 230 may involve choosing the at least one of the ads for display based at least in part on the type of content requested. In further related aspects, step 210 may further involve choosing for storage those ads associated with an ad header, wherein the ad header specifies ad parameters of the ad. In yet further related aspects, step 220 may involve detecting a given request for at least one content associated with a content header, wherein the content header specifies rules regarding which ones of the ads chosen for storage are to be shown in association with the at least one content. The step of displaying the at least one of the stored ads (step 230) may involve choosing for display the at least one stored ad based on the rules, such that the rules are satisfied by the ad parameters for the at least one stored ad.

In another embodiment, there is provided a method for targeted advertising that involves preloading ads on the mobile device from a host via a wireless connection based at least in part on a profile of the user. Each ad may include an ad header that specifies the parameters of the ad. The method may involve providing content to the mobile device from a host, wherein the content is associated with a content header that includes rules for the preloaded ads to be shown as the content starts to download or buffer. The method may involve selecting, at the mobile device, at least one preloaded ad based on the rules. The parameters in the ad header preferably satisfy the rules in the content header. The method may involve displaying the selected at least one preloaded ad on the mobile device screen for the user.

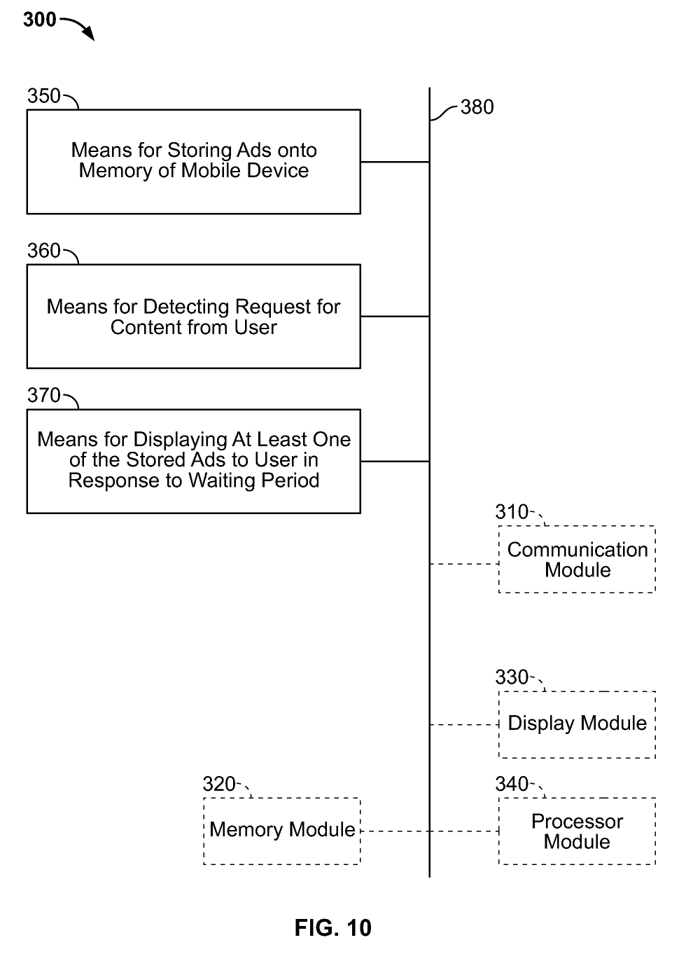

In accordance with one or more aspects of the embodiments described herein, there are provided apparatuses and devices for delivering targeted advertising to mobile device users. With reference to the flow chart shown in FIG. 10, there is provided an exemplary apparatus 300 that includes a communication module 310 adapted to receive ads selected from a library of ads based on profile of a user of the mobile device; a memory module 320 adapted to store the received ads; a display module 330; and a processor module 340 operatively coupled to the communication module 310, the memory module 320, and the display module 330. The memory module 330 may include executable code for the processor module 340 to: (a) detect a request for content from the user; and (b) in response to a waiting period associated with obtaining the requested content, instruct the display module 330 to display at least one of the ads in the memory module 320 to the user.

In related aspects, the requested content may be located at a remote site. The waiting period may include a pause during which the requested content downloads onto the mobile device. The waiting period may include a pause during which the requested content is buffered for presentation on the mobile device. The profile may be updated based at least in part on a type of content requested by the user and/or a geographic location of the user.

In further related aspects, each received ad may be associated with an ad header that specifies at least one ad parameter. The detected request may be for at least one content associated with a content header. The content header may specify rules regarding which ones of the received ads are to be shown in association with the at least one content. The at least one ad parameter for the at least one displayed ad preferably satisfies the rules specified by the content header.

It is noted that the apparatus 300 may optionally include a means 350 for storing ads onto a memory, wherein the ads may be selected from a library of ads based on a profile of a user. The apparatus 300 may optionally include a means 360 for detecting a request for content from the user, and a means 370 for displaying at least one of the stored ads to the user in association with a waiting period for obtaining the requested content. The processor module 340, in such case, may be in operative communication with the means 350, 360, and 370 via a bus 380 or similar communication coupling. The at least one processor 340 may effect initiation and scheduling of the processes or functions performed by the means 350, 360, and 370, and any components thereof.

In another embodiment, there is provided a mobile device for targeted advertising, including a memory module for storing preloaded ads. The stored preloaded ads may be selected at a remote host based at least in part on a profile of a user. Each ad may include or otherwise be in association with an ad header that specifies the parameters of the ad. The mobile device may include a receiver module for receiving content from a separate location, wherein the content is associated with a content header that includes rules for the preloaded ads to be shown when the content downloads or buffers. The mobile device may also include a processor module operatively coupled to the memory module and the receiver module. In related aspects, the memory module may include executable code for the processor module to select at least one preloaded ad based on the rules. The parameters of the ad header of the at least one preloaded ad may satisfy the rules specified by the content header.

In yet another embodiment, the mobile device may include a memory module for storing preloaded ads, wherein the stored preloaded ads are selected based at least in part on a profile of a user, and herein each ad is associated with an ad header. The mobile device may include a receiver module for receiving content from a separate location, wherein the content is associated with a content header. The mobile device may include a processor module adapted to select at least one preloaded ad based on rules of the content header. Parameters of the ad header associated with at least one preloaded ad preferably satisfies the rules of the content header.

In accordance with one or more aspects of the embodiments described herein, there is provided an exemplary method for providing targeted advertising to a user of a mobile device, comprising preloading ads on the mobile device from a host via a wireless connection based at least in part on a profile of the user, each ad comprising a first header that specifies the parameters of the advertisement. The method may further comprise wirelessly providing video content to the mobile device from a host, the video content being associated with a second header that comprises rules for the preloaded advertisements to be shown as the video content starts to download or buffer. The method may further comprise selecting, at the mobile device, at least one preloaded advertisement based on the rules, the parameters in the first header of the at least one preloaded advertisement satisfying the rules in the second header associated with the video content. The method may further comprise displaying the selected at least one preloaded advertisement on the mobile device screen for the user.

In accordance with one or more aspects of the embodiments described herein, there is provided an exemplary mobile device for providing targeted advertising to a user, comprising a memory module for storing preloaded advertisements, the stored preloaded advertisements being selected at a remote host based at least in part on a profile of the user, each advertisement comprising a first header that specifies the parameters of the advertisement. The mobile device may further comprise a receiver module for receiving video content from a separate location, the video content being associated with a second header that comprises rules for the preloaded advertisements to be shown as the video content starts to download or buffer, as well as a processor module operatively coupled to the memory module and the receiver module. The memory module may comprise executable code for the processor module to select at least one preloaded advertisement based on the rules, the parameters in the first header of the at least one preloaded advertisement satisfying the rules in the second header associated with the video content

In accordance with one or more aspects of the embodiments described herein, there is provided an exemplary mobile device for providing targeted advertising to a user, comprising a first memory for storing preloaded advertisements, the stored preloaded advertisements being selected at a remote host based at least in part on a profile of the user, each advertisement comprising a first header that specifies the parameters of the advertisement. The mobile device may further comprise a receiver module for receiving video content from a separate location, the video content being associated with a second header that comprises rules for the preloaded advertisements to be shown as the video content starts to download or buffer. The mobile device may further comprise a second memory comprising executable code, and a processor module operatively coupled to the first memory, the receiver module, and the second memory. The executable code may comprise instructions for the processor module to select at least one preloaded advertisement based on the rules, the parameters in the first header of the at least one preloaded advertisement satisfying the rules in the second header associated with the video content

In accordance with one or more aspects of the embodiments described herein, there is provided an exemplary mobile device for providing targeted advertising to a user, comprising a memory module for storing preloaded advertisements, the stored preloaded advertisements being selected based at least in part on a profile of the user, each advertisement comprising a first header that specifies the parameters of the advertisement. The mobile device may further comprise: a receiver module for receiving video content from a separate location, the video content being associated with a second header that comprises rules for the preloaded advertisements to be shown as the video content starts to download or buffer; and a processor module adapted to select at least one preloaded advertisement based on the rules, the parameters in the first header of the at least one preloaded advertisement satisfying the rules in the second header associated with the video content.

While the present invention has been illustrated and described with particularity in terms of preferred embodiments, it should be understood that no limitation of the scope of the invention is intended thereby. Features of any of the foregoing methods and devices may be substituted or added into the others, as will be apparent to those of skill in the art. It should also be understood that variations of the particular embodiments described herein incorporating the principles of the present invention will occur to those of ordinary skill in the art and yet be within the scope of the invention.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

It is understood that the specific order or hierarchy of steps in the processes disclosed herein in an example of exemplary approaches. Based upon design preferences, it is understood that the specific order or hierarchy of steps in the processes may be rearranged while remaining within the scope of the present disclosure The accompanying method claims present elements of the various steps in sample order, and are not meant to be limited to the specific order or hierarchy presented.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

What is claimed is:

1. A method for delivering targeted advertising to a user of a mobile device, comprising:
storing advertisements onto a memory of the mobile device, the advertisements being selected from a library of advertisements based on a profile of the user;
detecting a request for content from the user; and
in response to a waiting period associated with obtaining the requested content, displaying at least one of the stored advertisements to the user.

2. The method of claim 1, further comprising updating the profile based at least in part on a type of content requested by the user.

3. The method of claim 1, further comprising updating the profile based at least in part on a geographic location of the user.

4. The method of claim 1, wherein displaying the at least one of the stored advertisements comprises choosing the at least one of the advertisements for display based at least in part on the type of content requested.

5. The method of claim 4, wherein storing the advertisements onto the memory comprises choosing for storage those advertisements associated with an ad header, wherein the ad header specifies ad parameters of the advertisement.

6. The method of claim 5, wherein detecting the request for the content comprises detecting a given request for at least one content associated with a content header, wherein the content header specifies rules regarding which ones of the advertisements chosen for storage are to be shown in association with the at least one content.

7. The method of claim 6, wherein displaying the at least one of the stored advertisements comprises choosing for display the at least one stored advertisement based on the rules.

8. The method of claim 7, wherein the rules are satisfied by the ad parameters for the at least one stored advertisement.

9. A mobile device, comprising:
a communication module adapted to receive advertisements, the advertisements being selected from a library of advertisements based on profile of a user of the mobile device;
a memory module adapted to store the received advertisements;
a display module; and
a processor module operatively coupled to the communication module, the memory module, and the display module;
wherein the memory module comprises executable code for the processor module to:
detect a request for content from the user;
in response to a waiting period associated with obtaining the requested content, instruct the display module to display at least one of the advertisements in the memory module to the user.

10. The mobile device of claim 9, wherein the requested content is located at a remote site.

11. The mobile device of claim 9, wherein the waiting period comprises a pause during which the requested content downloads onto the mobile device.

12. The mobile device of claim 9, wherein the waiting period comprises a pause during which the requested content is buffered for presentation on the mobile device.

13. The mobile device of claim 9, wherein the profile is updated based at least in part on a type of content requested by the user.

14. The mobile device of claim 9, wherein the profile is updated based at least in part on a geographic location of the user.

15. The mobile device of claim 9, wherein each received advertisement is associated with an ad header that specifies at least one ad parameter.

16. The mobile device of claim 15, wherein the detected request is for at least one content associated with a content header, wherein the content header specifies rules regarding which ones of the received advertisements are to be shown in association with the at least one content.

17. The mobile device of claim 16, wherein the at least one ad parameter for the at least one displayed advertisement satisfies the rules specified by the content header.

18. An apparatus, comprising:
means for storing advertisements onto a memory, the advertisements being selected from a library of advertisements based on a profile of a user;
means for detecting a request for content from the user; and
means for displaying at least one of the stored advertisements to the user in association with a waiting period for obtaining the requested content.

19. The apparatus of claim 18, wherein the requested content is located at a remote site.

20. The apparatus of claim 18, wherein the waiting period comprises a pause during which the requested content is downloading.

21. The apparatus of claim 18, wherein the waiting period comprises a pause during which the requested content is being buffered.

22. The apparatus of claim 18, wherein the profile is updated based at least in part on a type of content requested by the user.

23. The apparatus of claim 18, wherein the profile is updated based at least in part on a geographic location of the user.

24. The apparatus of claim 18, wherein each stored advertisement is associated with an ad header that specifies at least one ad parameter.

25. The apparatus of claim 24, wherein the detected request is for at least one content associated with a content header, wherein the content header specifies rules regarding which ones of the stored advertisements are to be shown in association with the at least one content.

26. The apparatus of claim 25, wherein the at least one ad parameter for the at least one displayed advertisement satisfies the rules specified by the content header.

27. A computer program product, comprising:
a computer-readable medium comprising:
code for causing a computer to store advertisements onto a memory, the advertisements being selected from a library of advertisements based on a profile of a user;
code for causing a computer to detect a request for content from the user; and
code for causing a computer to display at least one of the stored advertisements to the user in association with a waiting period for obtaining the requested content.
